(19) United States
(12) Patent Application Publication
(10) Pub. No.: US 2009/0167478 A1
(43) Pub. Date: Jul. 2, 2009

(54) DEVICE FOR IMPROVING EDDY CURRENT LOSS OF TRANSFORMER AND CONTROLLING METHOD THEREOF

(75) Inventors: Ching-Ho Chou, Taoyuan Hsien (TW); Chen Hung-Ming, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 12/111,476

(22) Filed: Apr. 29, 2008

(30) Foreign Application Priority Data
Dec. 31, 2007 (TW) 96151613

(51) Int. Cl. H01F 27/02

(52) U.S. Cl. 336/84 C

(57) ABSTRACT

The configurations of a device diminishing the eddy current loss for a transformer having a gap are provided in the present invention. The proposed device includes a conductive case having an eddy current diminishing opening opposite to the air-gap and an insulator disposed between the eddy current diminishing opening and the transformer.

### FIELD OF THE INVENTION

The present invention relates to a device diminishing an eddy current loss for a transformer having an air-gap. More particularly, the present invention relates to a device diminishing an eddy current loss and having a conductive case with an eddy current diminishing opening.

### BACKGROUND OF THE INVENTION

To increase the density of one of the ICs and the electronic elements per unit area so as to cope with the trend of containing more electronic elements in per unit area/per unit volume, electronic products of nowadays are all pursuing to be even thinner, even lighter and even smaller. Due to these requirements, the printed circuit board (PCB) and electronic products are all going after the development of low-profile products. Since no matter they are the PCBs or the electronic products, the thinner they are manufactured the more electronic elements or subsystems could be contained in per unit volume. Thus, most of the electronic elements including a transformer have taken the low-profile designs. For example, FIG. 1 shows a sectional view of an electronic product having a transformer in the prior art. To save the space, most of the transformers employ the design of a horizontal type transformer nowadays. The electronic product 1 includes an upper cover of a conductive case 10, a transformer 11, a PCB 12 and a lower cover of a conductive case 13. The transformer 11 includes a core 111 and an air-gap 112 (see FIG. 2(a)). The electronic product 1 could be any electronic product having a transformer with an air-gap, for example, the electronic product could be selected from a group consisting of an electronic ballast, a built-in power supply apparatus of a liquid crystal display (LCD) and a built-in power supply apparatus of a laptop.

However, the aforementioned low-profile and horizontal designs would bring a significant drawback that is the air gap 112 of the transformer 11 will generate a fringing flux (as shown in FIG. 2(a)). When the fringing flux either contacts or goes through the conductive case 10, a current I (i.e. an eddy current as shown in FIGS. 2(b) to 2(c)) will be generated since the upper cover of the conductive case 10 cuts the fringing flux. This eddy current I flows through the upper cover of the conductive case 10, a loss (=I²R) will be generated since the upper cover of the conductive case 10 has a resistance R, and the loss is an eddy current loss.

Due to the global energy shortage, the energy source should be saved, and thus the diminishing/decreasing of the above-mentioned eddy current loss is an important issue, which should be commonly looked into by the industry and the consumers.

Keeping the drawbacks of the prior arts in mind, and employing experiments and research full-heartily and persistently, the applicant finally conceived a device for improving an eddy current loss of transformer and a controlling method thereof.

### SUMMARY OF THE INVENTION

It is therefore an object of the present invention to provide a device diminishing an eddy current loss for a transformer having an air-gap and the device is a conductive case having an eddy current diminishing opening so as to diminish the eddy current loss caused by the air-gap.

According to the first aspect of the present invention, a device diminishing an eddy current loss for a transformer having an air-gap includes a conductive case having an eddy current diminishing opening opposite to the air-gap, and an insulator disposed between the eddy current diminishing opening and the transformer.

Preferably, the eddy current diminishing opening is exactly opposite to the air-gap and is a single opening larger than the air-gap so as to diminish the eddy current loss caused by the transformer, the conductive case is a metal case, and the insulator is used to wrap the transformer so as to form an insulating layer.

Preferably, the eddy current diminishing opening is larger than the air-gap and includes a plurality of elongate covering areas and a plurality of elongate openings, each the covering area is a part of the conductive case, and two adjacent ones of the plurality of covering areas form one of the plurality of openings.

Preferably, each of the plurality of covering areas has a substantially equal width.

Preferably, each the covering area includes a first and a second terminals, within the eddy current diminishing opening, which are separate from each other except a direct connection through the covering area therebetween.

According to the second aspect of the present invention, an electronic product includes a transformer having an air-gap and a conductive case having an eddy current diminishing opening opposite to the air-gap so as to diminish an eddy current loss caused by the transformer.

Preferably, the eddy current diminishing opening is a single opening larger than the air-gap and the conductive case is a metal case.

Preferably, the eddy current diminishing opening includes a plurality of elongate covering areas and a plurality of elongate openings, two adjacent ones of the covering areas form one of the plurality of elongate openings, and each the covering area is a part of the conductive case and is separate from any other of the covering areas within the eddy current diminishing opening.

Preferably, each the covering area has a first and a second terminals, within the eddy current diminishing opening, which are separate from each other except a direct connection through the covering area therebetween.

Preferably, the electronic product is an electronic ballast.

Preferably, the electronic ballast is a low profile electronic ballast.

Preferably, the transformer is a horizontal type transformer.

Preferably, the conductive case includes an upper cover and a lower cover, and the upper cover includes the eddy current diminishing opening.

Preferably, the device further includes an insulator and a printed circuit board (PCB), wherein the transformer is disposed on the PCB, and the insulator is disposed between the eddy current diminishing opening and the transformer and wraps the PCB and the transformer so as to form an insulating layer.

According to the third aspect of the present invention, a controlling method of a device diminishing an eddy current loss for a transformer, wherein the transformer has an air-gap, and the device includes a conductive case having an eddy current diminishing opening opposite to the air-gap, includes steps of: (a) causing the air-gap to be covered by the eddy current diminishing opening; and (b) causing a fringing flux of the air-gap to go through the eddy current diminishing opening and to be separate from any other part of the conductive case except the eddy current diminishing opening.

Preferably, the step (b) further includes steps of: (b1) causing the plurality of covering areas to be separate from each other within the eddy current diminishing opening; and (b2) forming a plurality of eddy currents on each the covering area by the fringing flux, wherein the plurality of eddy currents are separate from each other, so as to diminish the eddy current loss.

Preferably, every adjacent two elongate openings define therebetween a respective covering area defining two opposite edges forming therebetween a respective eddy current.

Preferably, the air-gap in the step (a) is covered completely by the eddy current diminishing opening.

The present invention may best be understood through the following descriptions with reference to the accompanying drawings, in which:

### BRIEF DESCRIPTION OF THE DRAWINGS

FIG. 1 shows a sectional view of an electronic product having a transformer in the prior art;

FIG. 2(a) shows a top view of a transformer having an air-gap generating a fringing flux in the prior art;

FIG. 2(b) shows a sectional view of a transformer having an air-gap generating a fringing flux, wherein the fringing flux goes through a conductive case of an electronic product and generates an eddy current, in the prior art;

FIG. 2(c) shows a top view of a transformer having an air-gap generating a fringing flux, wherein the fringing flux goes through a conductive case of an electronic product and generates an eddy current, in the prior art;

FIGS. 3(a) to 3(f) respectively show a top view of a conductive case of an electronic product having a transformer according to the first to the sixth preferred embodiments of the present invention;

FIG. 4 shows a top view of the conductive case generating a plurality of eddy currents according to the third preferred embodiment of the present invention; and

FIG. 5 shows an exploded view of an electronic product having an transformer according to the seventh preferred embodiment of the present invention.

### DETAILED DESCRIPTION OF THE PREFERRED EMBODIMENT

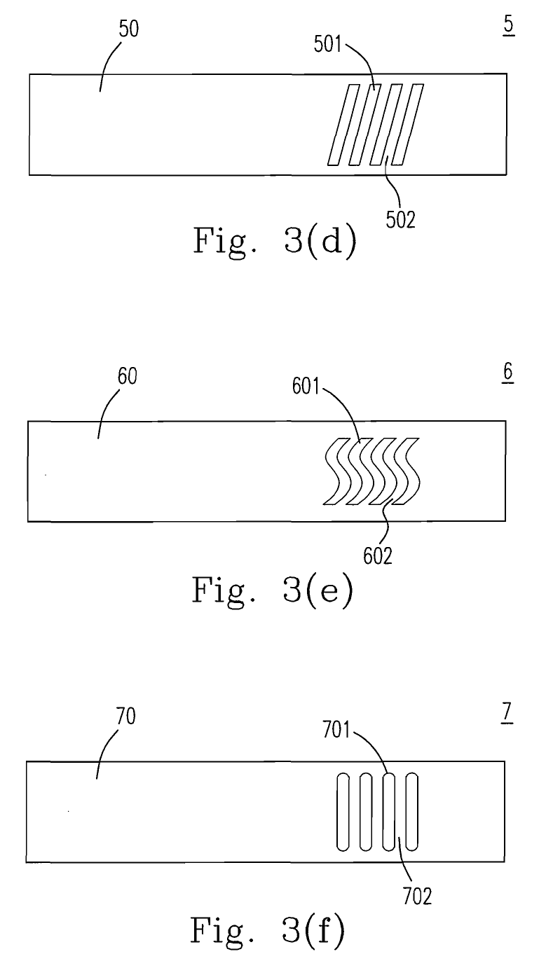

Please refer to FIG. 3(a), it shows a top view of a conductive case of an electronic product having a transformer according to the first preferred embodiment of the present invention. The electronic product 2 includes a transformer 11 (not totally shown) having a core 111 and an air-gap 112 and a conductive case 20, the conductive case 20 includes an eddy current diminishing opening 201. The air-gap 112 generates a fringing flux, which goes through outward to form a passing area, a dotted elliptical area as shown in FIG. 3(b). The eddy current diminishing opening 201 has to be larger than the passing through area, such that the fringing flux does not intersect with the conductive case 20 to completely diminish the aforementioned eddy current so as to avoid the transformer from generating an eddy current loss. Since the distance between the metal case and the electronic elements of the low-profile electronic product is relatively small, thus an insulator must be disposed in between the metal case and the electronic elements to avoid unnecessary electric leakage/discharging. Therefore, there is an insulator (not shown) in between the eddy current diminishing opening 201 and the transformer 11. Besides, a product tag (not shown also) will be stuck on the eddy current diminishing opening 201.

Please refer to FIG. 3(b), it shows a top view of a conductive case of an electronic product having a transformer according to the second preferred embodiment of the present invention. The electronic product 3 includes the transformer 11 also having the core 111 and the air-gap 112 (all are not shown) and a conductive case 30, the conductive case 30 includes a plurality of horizontally disposed, rectangular and elongate openings 301. The air-gap 112 generates a fringing flux, which goes through outward to form the above-mentioned passing area, the dotted elliptical area as shown in FIG. 3(b). An elongate covering area 302 is formed between two adjacent ones of the plurality of elongate openings 301. The union of the plurality of rectangular and elongate openings 301 and the plurality of elongate covering areas 302 forms a protection area (it is an eddy current diminishing opening according to the second preferred embodiment of the present invention, e.g., as shown in FIG. 3(c)), the protection area must be larger than the fringing flux passing area. Furthermore, each of the elongate covering areas 302 has a first terminal 3021 and a second terminal 3022. Within the eddy current diminishing opening, the first terminal 3021 and the second terminal 3022 of each the covering area 302 are separate from each other except a direct connection through the covering area 302 therebetween. That is to say, each the covering area 302 is separate from any other of the plurality of covering areas 302 within the protection area to avoid the generation of large amount of eddy current on the conductive case 30 (this will be further addressed latter on) so as to diminish the aforementioned eddy current loss generated by the transformer 11. There is an insulator (not shown) disposed among the plurality of elongate openings 301 and the transformer 11. Besides, a product tag (not shown also) will be stuck on the plurality of elongate openings 301 too. The advantage of the second preferred embodiment over the first preferred embodiment of the present invention is that it is easy to cope with the safety regulations such as the finger test. And the drawback of which is that a little bit of eddy current will be generated. Thus, the system efficiency of the second preferred embodiment of the present invention is relatively lower than the first preferred embodiment of the present invention.

Please refer to FIG. 3(c), it shows a top view of a conductive case of an electronic product having a transformer according to the third preferred embodiment of the present invention. The electronic product 4 includes the transformer 11 having the core 111 and the air-gap 112 also (all are not shown) and a conductive case 40, the conductive case 40 includes a plurality of vertically disposed, rectangular and elongate openings 401. This is the difference between the third preferred embodiment and the second preferred embodiment of the present invention, and the remaining operational principles, advantages and disadvantages are all the same as those of the second preferred embodiment of the present invention. An elongate covering area 402 is formed between two adjacent ones of the plurality of vertically disposed, rectangular and elongate openings 401. The union of the plurality of rectangular and elongate openings 401 and the plurality of elongate covering areas 402 forms the above-mentioned protection area (as shown in FIG. 3(c)), the protection area is also larger than the fringing flux passing area. Furthermore, each the elongate covering area 402 is separate from any other of the elongate covering areas 402 within the protection area to avoid the generation of a large amount of eddy current on the conductive case 40 so as to diminish the above-mentioned eddy current loss generated by the transformer 11.

Please refer to FIG. 3(d), it shows a top view of a conductive case of an electronic product having a transformer according to the fourth preferred embodiment of the present invention. The electronic product 5 includes the transformer 11 having the core 111 and the air-gap 112 too (all are not shown) and a conductive case 50, the conductive case 50 includes a plurality of inclined disposed, parallelogram-shaped and elongate openings 501. This is the difference among the third preferred embodiment and the first and the second preferred embodiments of the present invention. An elongate covering area 502 is formed between two adjacent ones of the plurality of inclined disposed, parallelogram-shaped and elongate openings 501. The remaining operational principles, advantages and disadvantages are all the same as those of the first and the second preferred embodiments of the present invention. The union of the plurality of parallelogram-shaped and elongate openings 501 and the plurality of elongate covering areas 502 forms the above-mentioned protection area (as shown in FIG. 3(c)), the protection area is also larger than the fringing flux passing area. Furthermore, each the elongate covering area 502 is separate from any other of the elongate covering areas 502 within the protection area to avoid the generation of a large amount of eddy current on the conductive case 50 so as to diminish the above-mentioned eddy current loss generated by the transformer 11.

Please refer to FIG. 3(e), it shows a top view of a conductive case of an electronic product having a transformer according to the fifth preferred embodiment of the present invention. The electronic product 6 includes the transformer 11 having the core 111 and the air-gap 112 also (all are not shown) and a conductive case 60, the conductive case 60 includes a plurality of s-shaped and elongate openings 601. This is the difference among the fifth preferred embodiment and the second to the fourth preferred embodiments of the present invention, and all the other operational principles, advantages and disadvantages are all the same as those of the second to the fourth preferred embodiments of the present invention. An elongate covering area 602 is formed between two adjacent ones of the plurality of s-shaped and elongate openings 601. The union of the plurality of s-shaped and elongate openings 601 and the plurality of elongate covering areas 602 forms the above-mentioned protection area (as shown in FIG. 3(c)), the protection area is also larger than the fringing flux passing area. Furthermore, each the elongate covering area 602 is separate from any other of the elongate covering areas 602 within the protection area to avoid the generation of a large amount of eddy current on the conductive case 60 so as to diminish the above-mentioned eddy current loss generated by the transformer 11.

Please refer to FIG. 3(f), it shows a top view of a conductive case of an electronic product having a transformer according to the sixth preferred embodiment of the present invention. The electronic product 7 includes the transformer 11 having the core 111 and the air-gap 112 too (all are not shown) and a conductive case 70, the conductive case 70 includes a plurality of hot dog shaped and elongate openings 701. This is the difference between the sixth preferred embodiment and the second to the fifth preferred embodiments of the present invention, and all the other operational principles, advantages and disadvantages are all the same as those of the second to the fifth preferred embodiments of the present invention. An elongate covering area 702 is formed between two adjacent ones of the plurality of hot dog shaped and elongate openings 701. The union of the plurality of hot dog shaped and elongate openings 701 and the plurality of elongate covering areas 702 forms the above-mentioned protection area (as shown in FIG. 3(c)), the protection area is also larger than the fringing flux passing area. Furthermore, each the elongate covering area 702 is separate from any other of the elongate covering areas 702 within the protection area to avoid the generation of a large amount of eddy current on the conductive case 70 so as to diminish the above-mentioned eddy current loss generated by the transformer 11.

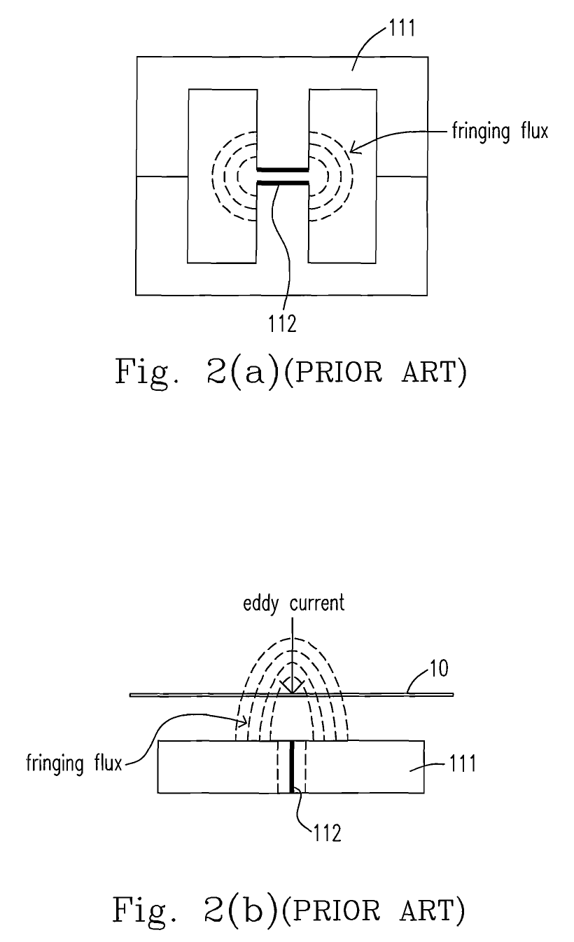

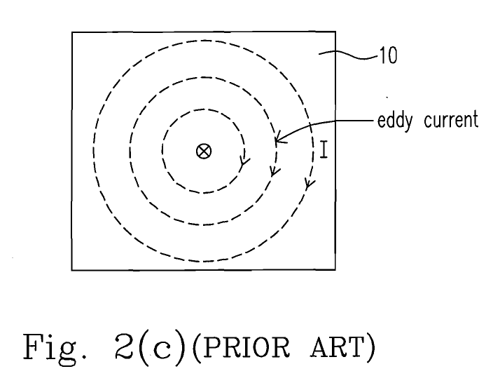

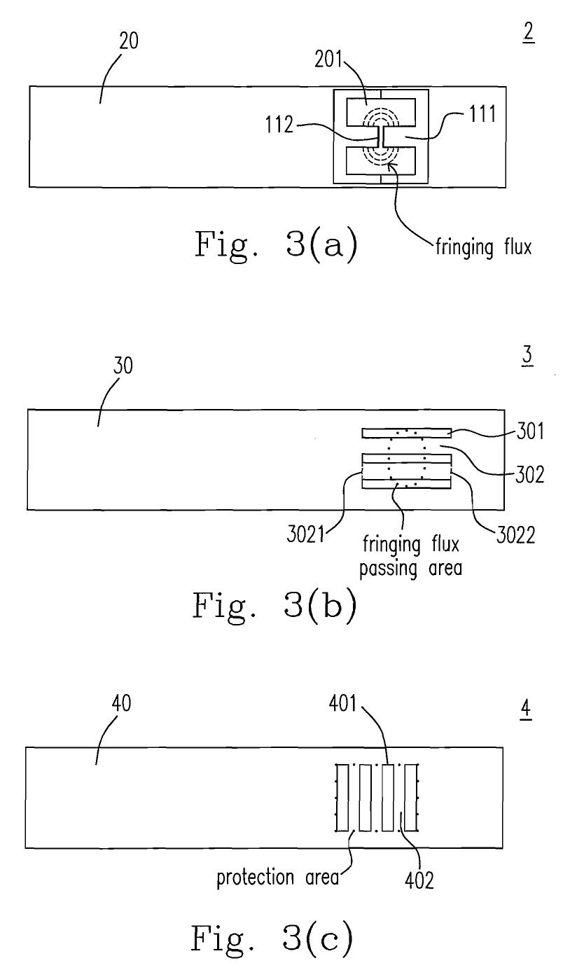

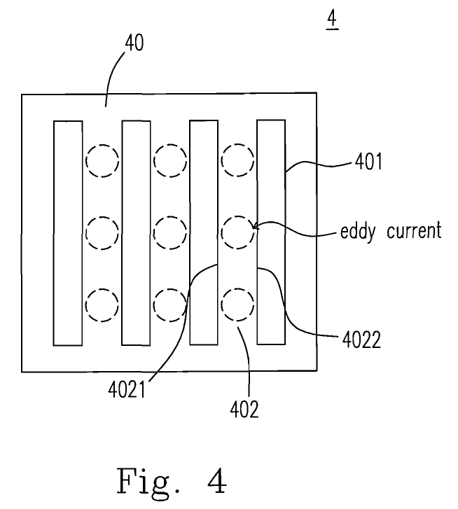

Please refer to FIG. 4, it shows a top view of the conductive case generating a plurality of eddy currents according to the third preferred embodiment of the present invention. In the third preferred embodiment of the present invention, the electronic product 4 includes the conductive case 40, and the conductive case 40 includes the plurality of vertically disposed, rectangular and elongate openings 401 and the plurality of elongate covering areas 402. There are a plurality of eddy currents formed on each of the plurality of elongate covering areas 402 and caused by the fringing flux passing each the covering area 402. Each the covering area 402 includes a first and a second edges 4021 and 4022. Every adjacent two elongate openings 401 define therebetween a respective covering area 402 defining the first and the second edges 4021 and 4022 forming therebetween a respective eddy current. Thus, the current values of the plurality of eddy currents on each the covering area 402 are much smaller than those of the eddy currents as shown in FIG. 2(c) so as to dramatically decrease the eddy current loss.

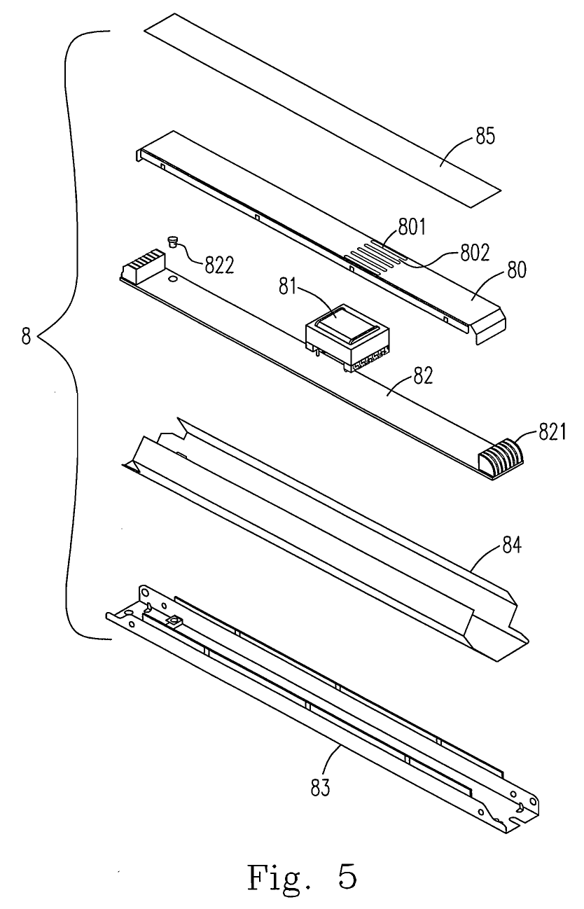

Please refer to FIG. 5, it shows an exploded view of a conductive case of an electronic product having a transformer according to the seventh preferred embodiment of the present invention. The electronic product 8 includes the transformer 81 having a core and an air-gap (which are not shown) and an upper cover of conductive case 80, the upper cover of conductive case 80 includes a plurality of hot dog shaped and elongate openings 801. An elongate covering area 802 is formed between two adjacent ones of the plurality of hot dog shaped and elongate openings 801. The union of the plurality of hot dog shaped and elongate openings 801 and the plurality of elongate covering areas 802 forms a protection area (not shown), which must be larger than a fringing flux passing area (not shown). Furthermore, the plurality of elongate covering area 802 are separate from each other within the protection area to avoid the generation of a large amount of eddy current on the upper cover of conductive case 80 so as to diminish the above-mentioned eddy current loss generated by the transformer 81. Besides, the electronic product 8 further includes a PCB 82 (including two terminals 821 and a screw 822) disposing the transformer 81, a lower cover of conductive case 83, an insulator 84 wrapping the PCB 82 and the transformer 81 so as to form an insulating layer and a product tag 85 sticking on the upper cover of conductive case 80.

### Experimental Results

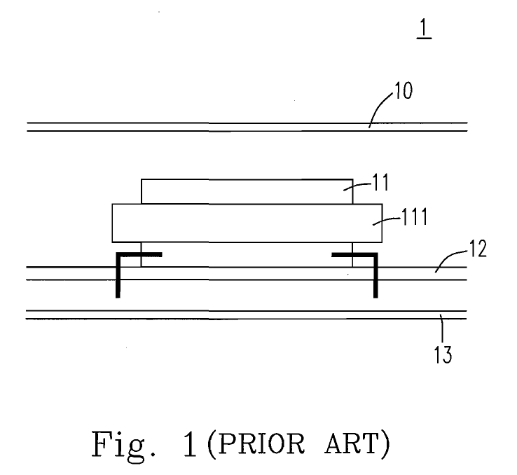

To verify the efficiency of the present invention, the present experiment is engaged with a high-frequency electronic ballast T5 and two 35 W florescent tubes. There are two groups: (product case) not improved group (see FIGS. 1 and 2(c)) and (product case) improved group (see FIG. 5 according to the seventh preferred embodiment of the present invention). For the two groups, the input voltages of the electronic ballasts are both 230 VAC, the input frequencies are both 50 Hz, the power factors are both 0.993 and the switching frequencies are both 72 KHz. Furthermore, the tube voltage of florescent tube one is 210 VAC, the tube current of which is 0.173 A, and the tube power of which is 35.6 W; the tube voltage of florescent tube two is 209 VAC, the tube current of which is 0.175 A, and the tube power of which is 35.84 W. The remaining experimental data of the not improved group and the improved group are listed in Table 1 as follows. The efficiency of the not improved group is 86.90%, the efficiency of the improved group is 90.67%, the improvement of the efficiency reaches 3.8%, and the achievement is quite significant regarding the decrease of an eddy current loss caused by a transformer included in the ballast T5.

TABLE 1
Comparison of the experimental data of the not
improved group and the improved group

| | Input | Tube | | |
|---|---|---|---|---|
| Parameters | Power | Power | Efficiency | Improvement |
| Not Improved group | 82.22 | 71.45 | 86.90% | |
| Improved group | 78.79 | 71.45 | 90.67% | 3.8% |

According to the aforementioned descriptions, a device diminishing an eddy current loss for a transformer having an air-gap is provided. The device is a conductive case having an eddy current diminishing opening, wherein the eddy current diminishing opening is a single opening opposite to the air-gap so as to diminish the eddy current loss generated by the air-gap. Furthermore, a second device diminishing an eddy current loss for a transformer having an air-gap is also provided. The second device is a conductive case having an eddy current diminishing opening, wherein the eddy current diminishing opening has a plurality of elongate covering areas and a plurality of elongate openings so as to diminish the eddy current loss generated by the air-gap. The air-gap generates a fringing flux passing outward to form a passing area. Two adjacent ones of the plurality of openings form one of the plurality of elongate covering areas (according to the aforementioned descriptions, each of the plurality of elongate covering areas could be in any shape that has a substantially equal width). The union of the plurality of elongate openings and the plurality of elongate covering areas forms a protection area larger than the fringing flux passing area. Furthermore, the plurality of elongate covering areas are separate from each other within the protection area to avoid the generation of a large amount of eddy current on the conductive case. Thus, the proposed device has a relatively better efficiency for diminishing/decreasing the eddy current loss generated by the transformer.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A device diminishing an eddy current loss for a transformer having an air-gap, comprising:
a conductive case having an eddy current diminishing opening opposite to the air-gap; and
an insulator disposed between the eddy current diminishing opening and the transformer.

2. A device according to claim 1, wherein the eddy current diminishing opening is exactly opposite to the air-gap and is a single opening larger than the air-gap so as to diminish the eddy current loss caused by the transformer, the conductive case is a metal case, and the insulator is used to wrap the transformer so as to form an insulating layer.

3. A device according to claim 1, wherein the eddy current diminishing opening is larger than the air-gap and includes a plurality of elongate covering areas and a plurality of elongate openings, each the covering area is a part of the conductive case, and two adjacent ones of the plurality of covering areas form one of the plurality of openings.

4. A device according to claim 3, wherein each of the plurality of covering areas has a substantially equal width.

5. A device according to claim 4, wherein each the covering area comprises a first and a second terminals, within the eddy current diminishing opening, which are separate from each other except a direct connection through the covering area therebetween.

6. An electronic product, comprising:
a transformer having an air-gap; and
a conductive case having an eddy current diminishing opening opposite to the air-gap so as to diminish an eddy current loss caused by the transformer.

7. An electronic product according to claim 6, wherein the eddy current diminishing opening is a single opening larger than the air-gap and the conductive case is a metal case.

8. An electronic product according to claim 6, wherein the eddy current diminishing opening includes a plurality of elongate covering areas and a plurality of elongate openings, two adjacent ones of the covering areas form one of the plurality of elongate openings, and each the covering area is a part of the conductive case and is separate from any other of the covering areas within the eddy current diminishing opening.

9. An electronic product according to claim 8, wherein each the covering area has a first and a second terminals, within the eddy current diminishing opening, which are separate from each other except a direct connection through the covering area therebetween.

10. An electronic product according to claim 6, wherein the electronic product is an electronic ballast.

11. An electronic product according to claim 10, wherein the electronic ballast is a low profile electronic ballast.

12. An electronic product according to claim 6, wherein the transformer is a horizontal type transformer.

13. An electronic product according to claim 6, wherein the conductive case comprises an upper cover and a lower cover, and the upper cover comprises the eddy current diminishing opening.

14. An electronic product according to claim 6 further comprising an insulator and a printed circuit board (PCB), wherein the transformer is disposed on the PCB, and the insulator is disposed between the eddy current diminishing opening and the transformer and wraps the PCB and the transformer so as to form an insulating layer.

15. A controlling method of a device diminishing an eddy current loss for a transformer, wherein the transformer has an air-gap, and the device comprises a conductive case having an eddy current diminishing opening opposite to the air-gap, comprising steps of:
(a) causing the air-gap to be covered by the eddy current diminishing opening; and
(b) causing a fringing flux of the air-gap to go through the eddy current diminishing opening and to be separate from any other part of the conductive case except the eddy current diminishing opening.

16. A method according to claim 15, wherein the device is the one as claimed in claim 2.

17. A method according to claim 15, wherein the device is the one as claimed in claim 5, and the step (b) further comprises steps of:
(b1) causing the plurality of covering areas to be separate from each other within the eddy current diminishing opening; and
(b2) forming a plurality of eddy currents on each the covering area by the fringing flux, wherein the plurality of eddy currents are separate from each other, so as to diminish the eddy current loss.

18. A method according to claim 17, wherein every adjacent two elongate openings define therebetween a respective covering area defining two opposite edges forming therebetween a respective eddy current.

19. A method according to claim 15, wherein the air-gap in the step (a) is covered completely by the eddy current diminishing opening.
